(19) United States
(12) Patent Application Publication
(10) Pub. No.: US 2013/0099600 A1
(43) Pub. Date: Apr. 25, 2013

(54) LINEAR VIBRATOR

(71) Applicant: LG INNOTEK CO., LTD., Seoul (KR)

(72) Inventor: Young Il PARK, Seoul (KR)

(73) Assignee: LG INNOTEK CO., LTD., Seoul (KR)

(21) Appl. No.: 13/658,187

(22) Filed: Oct. 23, 2012

(30) Foreign Application Priority Data
Oct. 24, 2011 (KR) 10-2011-0108590
Feb. 13, 2012 (KR) 10-2012-0014155

(51) Int. Cl. H02K 33/00

(52) U.S. Cl. 310/15

(57) ABSTRACT

A linear vibrator is disclosed, the linear vibrator including a case providing an inner space, a first driving unit arranged inside the case, a second driving unit arranged inside the case to be driven to a horizontal direction relative to the first driving unit, and an elastic unit arranged on lateral surfaces opposite the second driving unit to elastically support the second driving unit inside the case.

### CROSS-REFERENCE TO RELATED APPLICATIONS

This application claims the benefit under 35 U.S.C. §119 of Korean Patent Application Nos. 10-2011-0108590, filed Oct. 24, 2011, and 10-2012-0014155, filed Feb. 13, 2012, which are hereby incorporated by reference in their entirety.

### BACKGROUND

1. Field of the Disclosure

The present disclosure relates to a linear vibrator.

2. Description of Related Art

Generally, a linear vibrator is employed for generating vibration in electronic appliances, such as mobile phones, smart phones, gaming machines, portable information terminals, smart pads and game controllers, using electromagnetic force between a magnet and a coil.

A conventional linear vibrator is configured such that when a current is applied to a coil, operation of vibrator is initiated by electromagnetic force formed between the coil and the magnet to vertically vibrate the vibrator in association with elasticity of a spring relative to a stator.

However, the conventional linear vibrator has a disadvantage in that, when the vibration is generated by the vertical movement of the vibrator relative to the stator, vibration power is small and the linear vibrator comes to be voluminous.

In order to solve this disadvantage, a linear vibrator has been recently developed where a vibrator is arranged on an upper surface of a stator, and the vibrator is horizontally vibrated relative to the stator to generate vibration.

However, the conventional linear vibrator horizontally vibrating to generate vibration suffers from a disadvantage in that a large stress is applied to an elastic unit vibrating a vibrator to easily destroy or damage the elastic unit in a case a shock is applied from outside to a vibrating direction of the linear vibrator.

### BRIEF SUMMARY

The present disclosure is to provide a linear vibrator configured to greatly decrease size of the linear vibrator by generating vibration to a horizontal direction but to greatly increase vibration force.

Furthermore, the present disclosure is to provide a linear vibrator configured to inhibit destruction and damage of an elastic unit by forcibly stopping a vibrator in a case the vibrator is deviated from an effective vibration section by an outside shock during generation of vibration to a horizontal direction.

In order to achieve at least the above objects, in whole or in part, and in accordance with the purposes of the present disclosure, as embodied and broadly described, and in one general aspect of the present disclosure, there is provided a linear vibrator, the linear vibrator comprising: a case providing an inner space; a first driving unit arranged inside the case; a second driving unit arranged inside the case to be driven to a horizontal direction relative to the first driving unit; and an elastic unit arranged on lateral surfaces opposite the second driving unit to elastically support the second driving unit inside the case.

As apparent from the foregoing, there is an advantageous effect in the linear vibrator thus configured according to the present disclosure in that size of the linear vibrator can be greatly decreased by generating vibration to a horizontal direction while vibration force can be greatly increased.

Another advantageous effect is that an elastic unit can be inhibited from being destructed or damaged by forcibly stopping a vibrator, in a case the vibrator is deviated from an effective vibration section by an outside shock during generation of vibration to a horizontal direction.

### BRIEF DESCRIPTION OF THE DRAWINGS

The accompanying drawings, which are included to provide a further understanding of the disclosure, and which are incorporated in and constitute a part of this application, illustrate embodiments of the disclosure and together with the description serve to explain the principle of the disclosure. In the drawings:

FIG. 1 is an exploded perspective view illustrating a linear vibrator according to a first exemplary embodiment of the present disclosure;

FIG. 2 is a plane view illustrating an assembled linear vibrator of FIG. 1;

FIG. 3 is a cross-sectional view taken along line ‘I-I’ of FIG. 2;

FIG. 4 is a cross-sectional view taken along line ‘II-II’ of FIG. 2;

FIG. 5 is a perspective extract view illustrating a bottom case, a magnet and a flexible circuit substrate of FIG. 1;

FIG. 6 is a perspective view illustrating a flexible circuit substrate of FIG. 1;

FIG. 7 is an exploded perspective view illustrating a second driving unit of the linear vibrator of FIG. 1;

FIG. 8 is a plane view illustrating a linear vibrator according to a second exemplary embodiment of the present disclosure;

FIG. 9 is a cross-sectional view taken along line ‘III-III’ of FIG. 8;

FIG. 10 is a plane view illustrating a bottom case of FIG. 9;

FIG. 11 is a perspective view of FIG. 10;

FIG. 12 is a plane view illustrating a stator and a bottom case of FIG. 9;

FIG. 13 is a cross-sectional view taken along line ‘IV-IV’ of FIG. 12;

FIG. 14 is a plane view illustrating a second driving unit and an upper case of FIG. 9; and

FIG. 15 is a lateral view of ‘A’ direction of FIG. 14.

### DETAILED DESCRIPTION

Hereinafter, exemplary embodiments of the present disclosure will be described in detail with reference to the accompanying drawings. In the drawings, sizes or shapes of constituent elements may be exaggerated for clarity and convenience.

In describing the present disclosure, detailed descriptions of constructions or processes known in the art may be omitted to avoid obscuring appreciation of the invention by a person of ordinary skill in the art with unnecessary detail regarding such known constructions and functions.

Accordingly, particular terms may be defined to describe the disclosure in the best mode as known by the inventors. Accordingly, the meaning of specific terms or words used in the specification and the claims should not be limited to the literal or commonly employed sense, but should be construed in accordance with the spirit and scope of the disclosure. The definitions of these terms therefore may be determined based on the contents throughout the specification.

Now, construction and operation of the linear vibrator according to the exemplary embodiments of the present disclosure will be described in detail with reference to the accompanying drawings.

### First Exemplary Embodiment

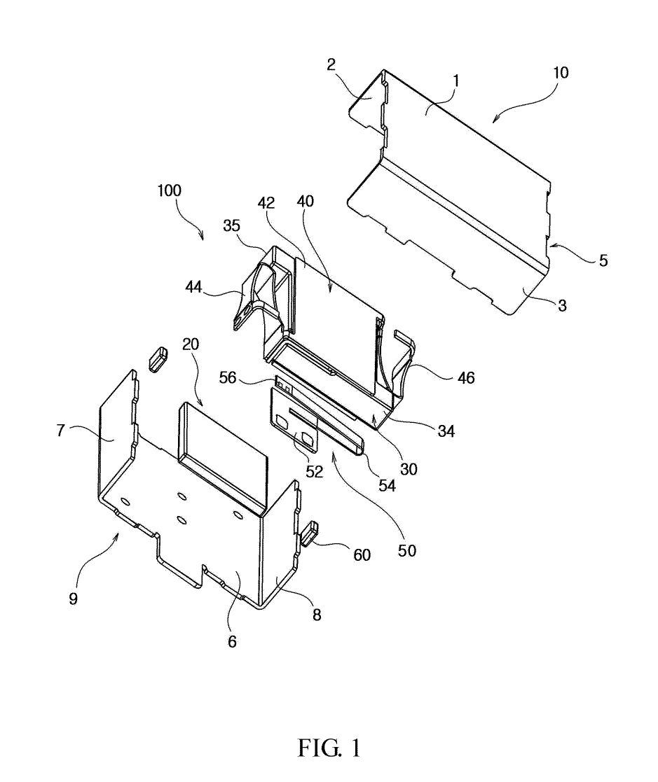

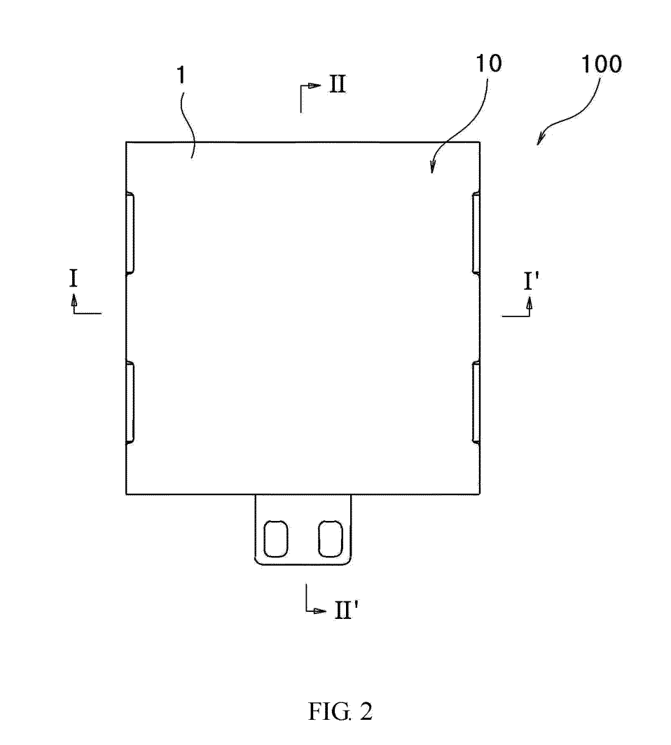

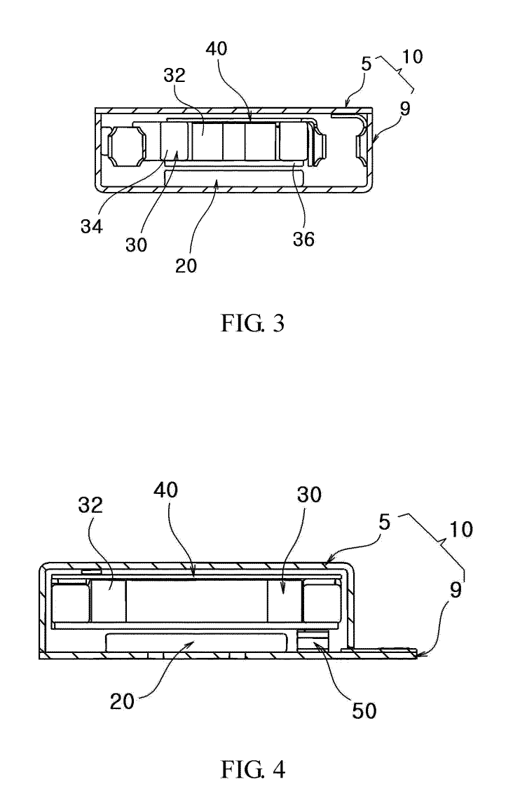

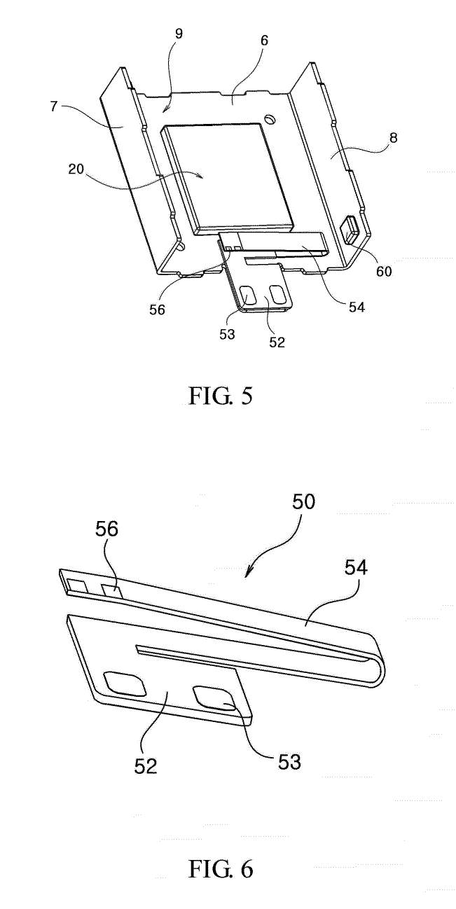

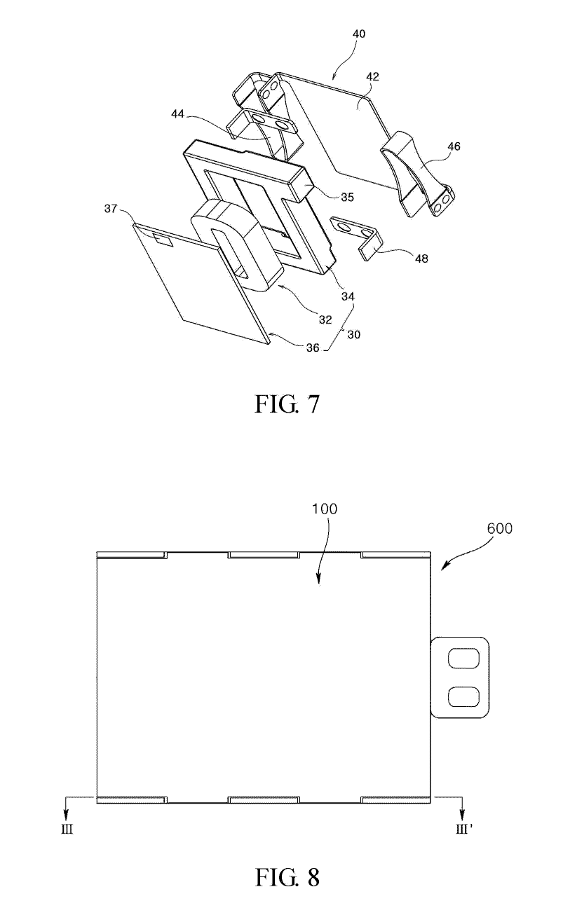

FIG. 1 is an exploded perspective view illustrating a linear vibrator according to a first exemplary embodiment of the present disclosure, FIG. 2 is a plane view illustrating an assembled linear vibrator of FIG. 1, FIG. 3 is a cross-sectional view taken along line ‘I-I’ of FIG. 2, FIG. 4 is a cross-sectional view taken along line ‘II-II’ of FIG. 2, FIG. 5 is a perspective extract view illustrating a bottom case, a magnet and a flexible circuit substrate of FIG. 1, FIG. 6 is a perspective view illustrating a flexible circuit substrate of FIG. 1, and FIG. 7 is an exploded perspective view illustrating a second driving unit of the linear vibrator of FIG. 1.

Referring to FIGS. 1 to 7, a linear vibrator (90) includes a case (10) providing an inner space, a first driving unit (20) arranged inside the case (10), a second driving unit (30) arranged inside the case to be driven to a horizontal direction relative to the first driving unit (20), and an elastic unit (40) elastically supporting the second driving unit (30) to the case (10). In addition, the linear vibrator may further include a flexible circuit substrate (50) in the first exemplary embodiment of the present disclosure.

The case (10) forms an accommodation space for accommodating the first driving unit (20), the second driving unit (30), the elastic unit (40) and the flexible circuit substrate (50). The case (10) may include an upper case (5) and a bottom case (9). The upper case (5) and the bottom case (9) in the exemplary embodiment of the present disclosure may include a magnetic substance for inhibiting leakage of magnetic field generated from a magnet which is the first driving unit (20, described later). For example, the case (10) may be formed by press-work of a metal plate inhibiting a magnetic field.

The upper case (5) includes an upper plate (1), and upper lateral plates (2, 3) formed at both edges of the upper plate (1), each facing the other upper lateral plate. The bottom case (9) includes a bottom plate (6), and bottom lateral plates (7, 8) formed at both edges of the bottom plate (6), each facing the other upper lateral plate. The upper lateral plates (2, 3) of the upper case (5) and the bottom lateral plates (7, 8) of the bottom case (9) are meshed together, whereby an accommodation space is formed inside the upper case (5) and the bottom case (9).

The first driving unit (20) is secured inside the case (10), and the first driving unit (20) in the exemplary embodiment of the present disclosure includes a magnet. The magnet may be formed, for example, in the shape of a rectangular parallelepiped having a thin thickness. The first driving unit (20) including the magnet is secured, for example, to an upper surface of the bottom plate (6) of the bottom case (9)

Referring to FIGS. 1 to 7 again, the second driving unit (30) includes a coil block (32), a weight (34) and a circuit substrate (36).

The coil block (32) of the first driving unit (30) is structured thereinside with a slit-shaped opening by winding a long wire insulated by an insulation resin, and as the coil block (32) is applied with a current, an electromagnetic field is generated from the coil block (32). The coil block (32) is arranged opposite to the first driving unit (20) including the magnet, and the coil block (32) and the first driving unit (20) are spaced apart at a predetermined distance.

The second driving unit (30) in the exemplary embodiment of the present disclosure is arranged on an upper surface of the first driving unit (20), and reciprocally and horizontally moves to a horizontal direction relative to the first driving unit (20).

The weight (34) is formed with an accommodation space for accommodating the coil block (32), and serves to increase vibration force of the linear vibrator (90). Each lateral surface opposite to the weight (34) is formed with a lug (35), where each lug (35) is symmetrically formed on the lateral surface opposite to the weight (34) based on a center of the weight. The lug (35) of the weight (34) is arranged opposite to a damping magnet (described later).

The circuit substrate (36) is electrically connected to the coil block (32) and secured to the circuit substrate (36). The circuit substrate (36) secured by the coil block (32) is in turn secured to the weight (34). The circuit substrate (36) may include a rigid circuit substrate or a flexible circuit substrate. The circuit substrate (36) in the exemplary embodiment of the present disclosure, if included with a flexible circuit substrate, may be secured to the case (10) by being bent.

Meanwhile, a rear surface of the circuit substrate (36) opposite to the first driving unit (20) is formed with a first terminal unit (37) electrically connected to the coil block (32), and the first terminal unit (37) is electrically connected to the flexible circuit substrate (50) applied with an outside driving signal. The linear vibrator (90) includes a magnet which is the first driving unit (20) secured to the case (10), and the second driving unit (30) includes the coil block (32).

Alternatively, even if the case (10) is arranged with the second driving unit (30), and a magnet is arranged on an upper surface of the second driving unit (30) as the first driving unit (20), the case (10), being formed with a magnetic substance, can improve the vibration force by inhibiting the magnetic flux from leaking from the magnet. However, in a case center of the magnet is biased to any one of the upper case (5) and the bottom case (9) of the case (10) amidst assembly, a vibrating magnet may be sucked into the upper case (5) or the bottom case (9) of the case (10) to greatly decrease the vibration characteristic of the second driving unit (30).

In order to solve the aforementioned problem, the upper case (5) or the bottom case (9) may be formed with non-magnetic substance that is not affected by magnetic field of the magnet, but the vibration force may decrease due to leakage of magnetic flux to generate a peak area at a frequency response curve relative to the vibration force, whereby the vibration force may be abruptly changed by a small change alone in resonant frequency.

Furthermore, in a case the upper case (5) or the bottom case (9) is formed with a non-magnetic substance, a vibration direction of the second driving unit (30) may be distorted by interference caused by magnetic field generated from an outside magnet mounted on a speaker arranged near to the linear vibrator (90), vibration force may decrease or the case (10) may collide with the second driving unit (30).

Still furthermore, in a case a magnet is used for the second driving unit (30), the volume of the magnet greatly may increase to in turn increase the manufacturing cost.

In the exemplary embodiment of the present disclosure, in a case the first driving unit (20) secured to the case (10) includes a magnet, a vibrating second driving unit (30) includes the coil block (32), the case (10) including the upper case (5) and the bottom case (9) can be formed with a magnetic substance, and a magnetic field generated by the outside magnet mounted on the speaker can be blocked to inhibit generation of interference due to formation of the case (10) with the magnetic substance, whereby magnetic volume can be greatly reduced to in turn reduce the manufacturing cost.

Referring to FIGS. 1 to 7 again, the elastic unit (40) includes a back yoke unit (42) and spring units (44, 46). The back yoke unit (42) is formed in the shape of a plate covering the weight (34), and the back yoke unit (42) is secured to the weight (34). The spring units (44, 46) are symmetrically formed on both lateral surfaces opposite to the back yoke unit (42) relative to a center of the back yoke unit (42), and each of the spring units (44, 46) takes a shape of a rectangular parallelepiped bent at least once.

The back yoke unit (42) and the spring units (44, 46) of the elastic unit (40) in the exemplary embodiment of the present disclosure are integrally formed and may be manufactured by a press work. In a case the back yoke unit (42) and the spring units (44, 46) of the elastic unit (40) are integrally formed using the press work, an area where the back yoke unit (42) and the spring units (44, 46) are connected may be easily destructed by fatigue due to actions of the spring units (44, 46).

In the exemplary embodiment of the present disclosure, the elastic unit (40) may arrange a spring guide (48) at the area where the back yoke unit (42) and the spring units (44, 46) are connected to thereby inhibit the destruction of the spring units (44, 46). The spring guide (48) may take an ‘L’-shaped bracket, for example. One side of the spring guide (48) is secured to the back yoke unit (42), and the other side of the spring guide (48) facing the one side of the spring guide (48) is secured to the spring units (44, 46).

Meanwhile, in the exemplary embodiment of the present disclosure, in a case the magnet including the first driving unit (20) is secured to the case (10), and the second driving unit (30) arranged at an upper surface of the magnet includes the coil block (32), a connection member may be needed to applying a driving signal to the coil block (32) of the vibrating second driving unit (30). The flexible circuit substrate (50) serves to apply a driving signal applied from outside to the circuit substrate (36) connected to the coil block (32) of the second driving unit (30).

Referring to FIGS. 1 to 7 once again, the flexible circuit substrate (50) includes a body (52), a bent unit (54) and a second terminal unit (56).

The body (52) includes a connection terminal (53) applied with the outside driving signal, and the body (52) is arranged at a position near to the magnet secured to the bottom plate (6) of the bottom case (9). The bent unit (54) is integrally formed with the body (52). The bent unit (54) takes a shape of a strip. The bent unit (54) takes a shape of being bent at least once to a vibration direction of the second driving unit (30). The second terminal unit (56) is formed at a distal end of the bent unit (54). The second terminal unit (56) is electrically connected to the first terminal unit (37) of the circuit substrate (36) electrically connected to the coil block (32).

The body (52), the bent unit (54) and the second terminal unit (56) may be integrally formed. Furthermore, the body (52) and the bent unit (54) may be formed with wirings to electrically connect a connection terminal (53) of the body (52) to the second terminal unit (56).

Meanwhile, even if the second driving unit (30) vibrates while the body (52) of the flexible circuit substrate (50) is secured to the bottom case 99), the flexible circuit substrate (50) is not short-circuited by the bent unit (54).

The linear vibrator (90) in the exemplary embodiment of the present disclosure may further include a damping magnet (60). The damping magnet (60) is secured to bottom lateral plates (7, 8) of the bottom case (9) opposite to a lug (35) protruded from the weight (34) of the second driving unit (30), for example, and arranged with a magnetic substance capable of absorbing a shock. The magnetic substance is absorbed by the magnetic field, and in turn absorbs the shock applied from outside.

As apparent from the foregoing, the linear vibrator according to the exemplary embodiment of the present disclosure has an advantageous effect in that a horizontal vibration is realized to reduce the volume of the linear vibrator, a case is formed with a magnetic substance to enhance the vibration force, the case is secured by a magnet, and a coil block is made to vibrate at an upper surface of the magnet, whereby volume of the magnet is reduced to greatly reduce the manufacturing cost.

### Second Exemplary Embodiment

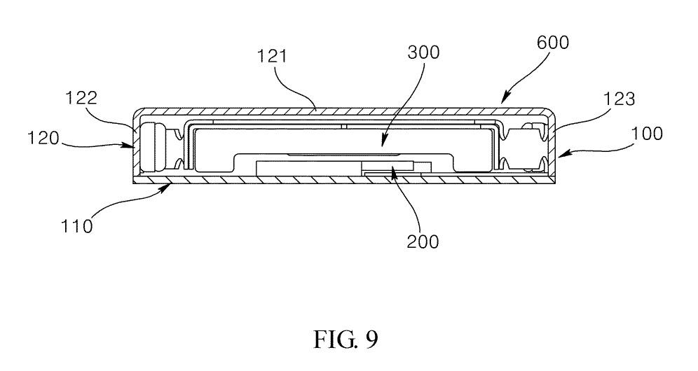

FIG. 8 is a plane view illustrating a linear vibrator according to a second exemplary embodiment of the present disclosure, and FIG. 9 is a cross-sectional view taken along line ‘III-III’ of FIG. 8.

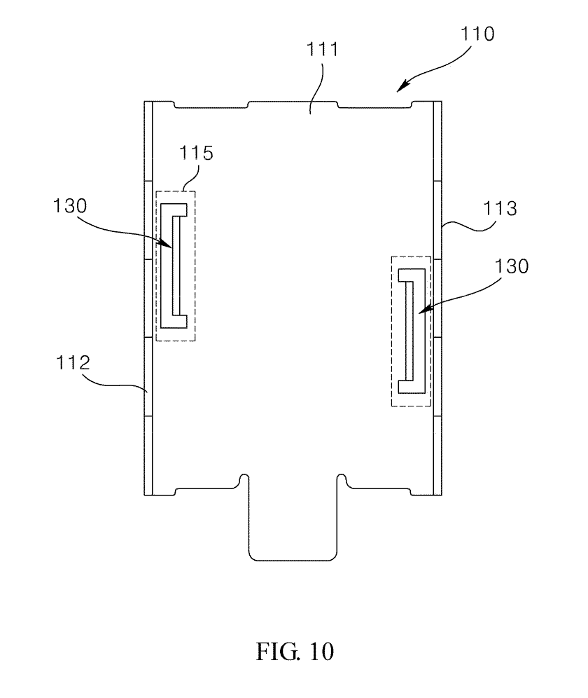

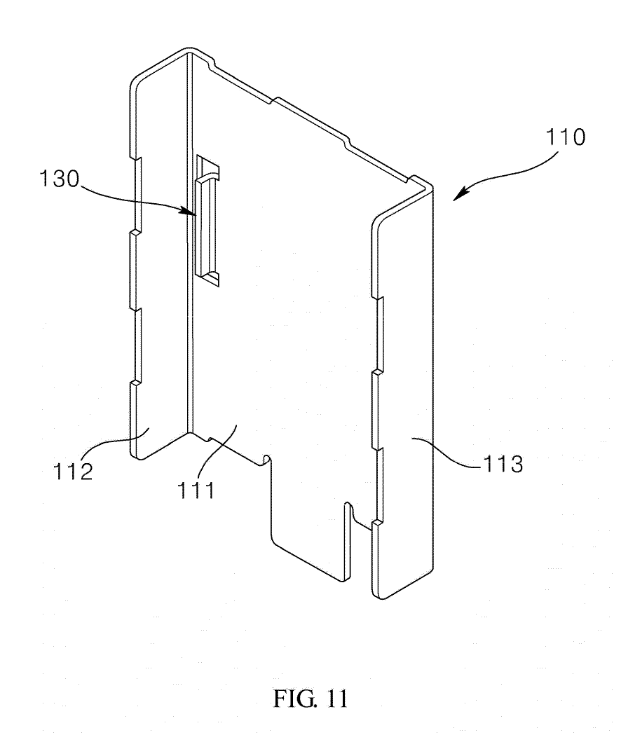

Referring to FIGS. 8 and 9, a linear vibrator (600) includes a case (100), a first driving unit (200), a second driving unit (300) and an elastic unit (330). FIG. 10 is a plane view illustrating a bottom case of FIG. 9, and FIG. 11 is a perspective view of FIG. 10.

Referring to FIGS. 8 to 10, the case (100) includes a bottom case (110) and an upper case (120). The case (100) in the exemplary embodiment of the present disclosure includes a stopper (described later) inhibiting the second driving unit (300) from exceeding a normal moving range. The bottom case (110) includes a floor plate (1110 and lateral plates (112, 113) vertically bent or vertically bent relative to the floor plate (111) from both edges opposite to the floor plate (111).

Referring to FIG. 9, the upper case (120) is coupled to the bottom case (110), and the upper case (120) includes a floor plate (121) and lateral plates (122, 123) vertically extended or vertically bent relative to the floor plate (111) from both edges opposite to the floor plate (121). The bottom case (110) and the upper case (120) are meshed together, whereby the bottom case (110) and the upper case (120) form an accommodation space thereinside.

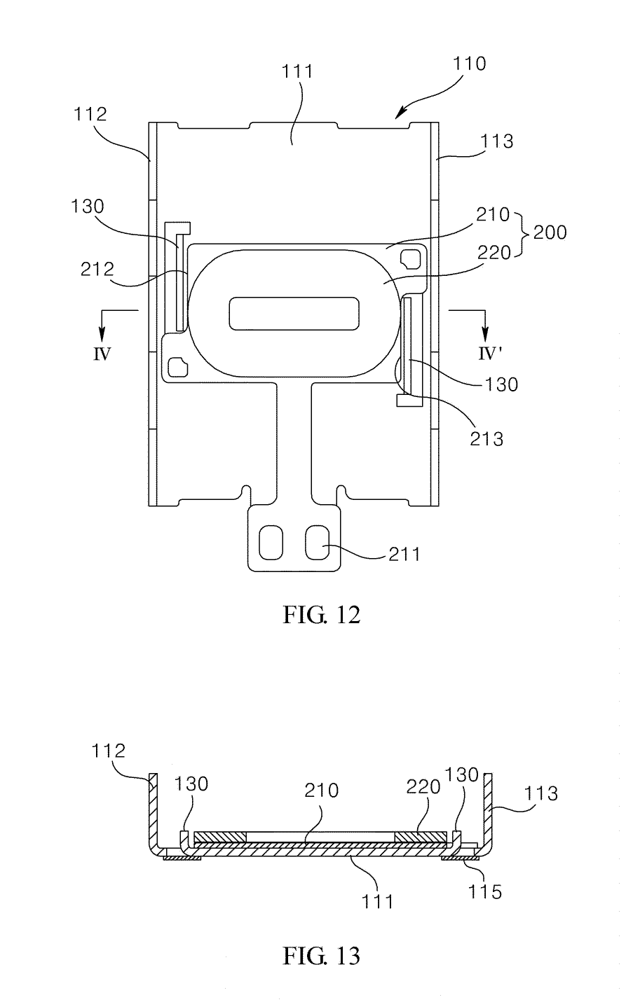

FIG. 12 is a plane view illustrating a stator and a bottom case of FIG. 9, and FIG. 13 is a cross-sectional view taken along line ‘IV-IV’ of FIG. 12.

Referring to FIGS. 12 and 13, the first driving unit (200) includes a circuit substrate (210) and a coil block (220). The circuit substrate (210) is arranged on the floor plate (111) of the bottom case (110), and a part of the circuit substrate (210) is extended to an outside of the bottom case (110). The circuit substrate (210) extended to the outside of the bottom case (110) is formed with a connection terminal (211) applied by a driving signal. The circuit substrate (210) may include a FPCB (Flexible Printed Circuit Board) interposed between the floor plate (111) of the bottom case (110) and the coil block (220). The circuit substrate (210) is formed with escape units (212, 213) inhibiting from being interfered with stoppers (described later) of the bottom case (110). The coil block (220) is arranged on an upper surface of the circuit substrate (210). The coil block (220) is formed by winding a long wire insulated by an insulation resin to thereby form a square opening thereinside. Both distal ends of the wire forming the coil block (220) are electrically connected to the circuit substrate (210).

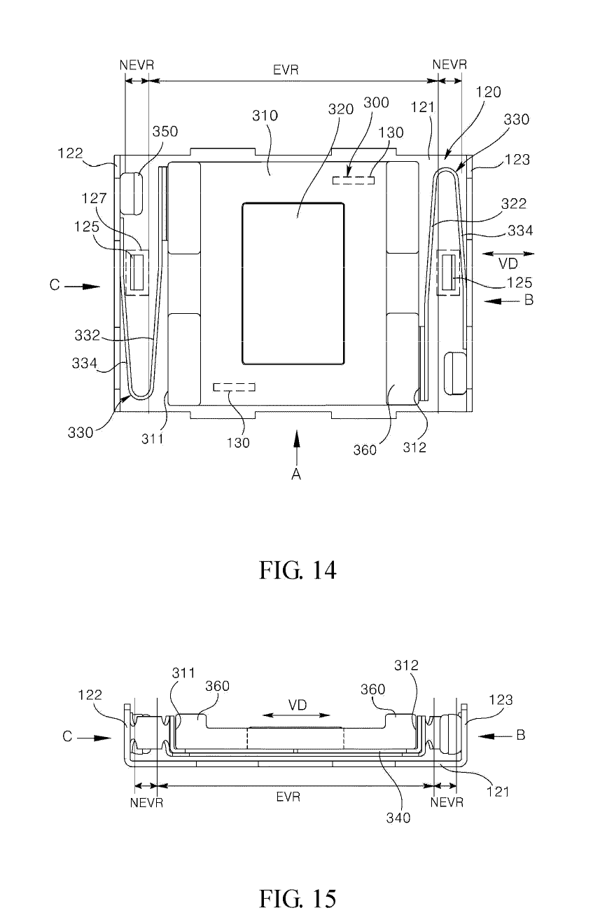

FIG. 14 is a plane view illustrating a second driving unit and an upper case of FIG. 9, and FIG. 15 is a lateral view of ‘A’ direction of FIG. 14.

Now, referring to FIGS. 9, 14 and 15, the second driving unit (300) is arranged at an upper surface of the first driving unit (200). Referring to FIG. 14, the second driving unit (300) vibrates to a vibration direction (VD) of the first driving unit (200), and a vibration is generated by movement of the second driving unit (300). The second driving unit (300) includes a weight (310), a magnet (320) and a back yoke (340). The second driving unit (300) is arranged with a collision inhibition member (350) inhibiting the case (100) from colliding with the second driving unit (300).

The weight (310) takes a shape of a rectangular parallelepiped block, for example. The weight (310) is centrally formed with an opening having a size and a shape adequate to fix the magnet (320, described later). The weight (310) serves to increase a weight of the second driving unit (300) to enhance the vibration force.

The magnet (320) of the second driving unit (300) is arranged at a position opposite to the coil block (220) of the first driving unit (200). The magnet (320) is inserted into and coupled with the weight of the opening. The back yoke (340) of the second driving unit (300) is secured to the weight (310),

The back yoke (340) functions to inhibit leakage of magnetic field generated from the magnet (320) and to further enhance the vibration force of the second driving unit (300).

The elastic unit (330) may be coupled to both lateral surfaces (311, 312) opposite to the weight (310) formed in the shape of a rectangular parallelepiped block by way of welding or an adhesive. A pair of elastic units (330) respectively coupled to the both lateral surfaces (311, 312) opposite to the weight (310) in the exemplary embodiment of the present disclosure are symmetrically arranged based on the center of the weight (310).

Each of the pair of elastic units (330) includes a first elastic unit (332) and a second elastic unit (334). The elastic unit (330) in the exemplary embodiment of the present disclosure is formed by a leaf spring bent at an acute angle. The first elastic unit (332) is bent opposite to the second elastic unit (334). Each of the first elastic units (332) of the pair of elastic units (330) is coupled to each of the lateral surfaces (311, 312) of the weight (310), and each of the second elastic units (334) is coupled to each lateral plate (122, 123) of the upper case (120).

To be more specific, each of the first elastic units (332) of each of the elastic units (330) is formed in a shape of a rectangle, for example, and each of the second elastic units (334) is bent at an acute angle relative to the first elastic unit (332). Each of the first elastic units (332) is coupled to the both lateral surfaces (311, 312) of the weight (310) of the second driving unit (300), and each of the second elastic units (334) is secured to each of the lateral plates (122, 123) of the upper case (120).

The magnetic field generated by the magnet (320) of the second driving unit (300) receives an attractive force or a repulsive force by the magnetic field generated by the coil block (220) of the first driving unit (200), illustrated in FIGS. 12 and 13, whereby the second driving unit (300) reciprocates to a VD (Vibrating Direction) of FIG. 14.

Now, a range or a scope where the second driving unit (300) normally vibrates (or a normal moving scope) is defined as a EVR (Effective Vibration Range), and the Effective Vibration Range is indicated in FIG. 14 as an EVR. That is, the second driving unit (300) vibrates within the EVR, where the EVR in the linear vibrator (600) may differ based on configuration and structure of the elastic unit (330) and the second driving unit (300).

Meanwhile, as shown in FIG. 14, in a case a large shock and/or vibration is applied to a direction (B) parallel with the VD of the second driving unit (300), the second driving unit (300) quickly moves to the lateral plate (122) of the upper case (120) by a shock amount generated by shock and/or collision.

Furthermore, as shown in FIG. 14, in a case a large shock and/or vibration is applied to a direction (C) parallel with the VD of the second driving unit (300), the second driving unit (300) quickly moves to the lateral plate (123) of the upper case (120) by a shock amount generated by shock and/or collision. As noted above, in a case the second driving unit (300) moves to any one direction of the lateral plates (122, 123) of the upper case (120) by the shock and/or vibration, the second driving unit (300) deviates from the EVR.

Now, a range or a scope deviated from an outer range of EVR is defined as NEVR (Non-Effective Vibration Range).

In a case the second driving unit (300) enters the NEVR from EVR by an outside shock and/or vibration, a large stress is applied to the elastic unit (330) to change an elastic coefficient of the elastic unit (330) or to destroy the elastic unit (330), whereby the second driving unit (300) may be vibrated to generate a large noise or no vibration may be generated from the linear vibrator (600).

In order to inhibit the elastic unit (330) from being destroyed, as the second driving unit (300) is moved from the EVR to NEVR by the shock and/or vibration applied from the outside in the exemplary embodiment of the present disclosure, as illustrated in FIGS. 10 and 11, the case (100) is formed with a stopper (133), and as illustrated in FIGS. 14 and 15, the second driving unit (300) is formed with a stopper (360).

The stopper (130) is hitched at a stopper unit (360) of the second driving unit (300) when the second driving unit (300) enters the NEVR to forcibly stop the second driving unit (300), whereby the elastic unit (330) is inhibited from being destroyed or damaged.

Referring to FIGS. 10 to 13 again, the stopper (130) may be formed at the floor plate (111) of the bottom case (110) of the case (300), for example. The stopper (130) may be formed by cutting a part of the floor plate (111) of the bottom case (110) and by bending the cut-out portion inwardly from the floor plate (111) of the bottom case (110).

The stopper (130) formed by partially cutting the floor plate (111) of the bottom case (110) and bending the cut-out portion may be formed in a pair at both sides of the coil block (220) of the first driving unit (200), and the stopper (130) is formed at a position corresponding to the escape units (212, 213) of the circuit substrate (210). Each of the pair of stoppers (130) formed at both sides of the coil block (220) is arranged within the EVR of the second driving unit (300).

The stopper (360) formed on the second driving unit (300) is formed in the direction the stopper (130) is hitched at, and the stopper (360) may be protruded to a direction facing the coil block (220) from both distal ends of a bottom surface of the weight (310) of the second driving unit (300). The stopper (360) may be formed in a shape of a line when viewed from a plane view.

Referring to FIG. 14, in a case a shock is applied to the linear vibrator (600) to the B direction, the second driving unit (300) moves to the C direction, whereby the second driving unit (300) tries to enter a right NEVR of FIG. 14. The left stopper (130) and the right stopper (360) of FIG. 14 are mutually brought into contact in a case the second driving unit (300) enters the NEVR, whereby the second driving unit (300) is stopped from entering the right NEVR.

Meanwhile, in a case a shock is applied to the linear vibrator (600) to the C direction, the second driving unit (300) moves to the B direction, whereby the second driving unit (300) tries to enter a left NEVR of FIG. 14. The left stopper (130) and the right stopper (360) of FIG. 14 are mutually brought into contact in a case the second driving unit (300) enters the left NEVR, whereby the second driving unit (300) is stopped from entering the left NEVR.

Meanwhile, in a case a part of the floor plate (11) of the bottom case (110) of the case (100) is cut and bent to form the stopper (130), a foreign object may enter into an interior of the case (100) through the opening formed in the course of forming the stopper (130).

In order to inhibit the foreign object from entering into the interior of the case (100) through the opening formed in the course of forming the stopper (130) in the exemplary embodiment of the present disclosure, an outside of the floor plate (111) of the bottom case (110) may be formed with a foreign object infuse inhibition membrane (115) covering the opening as illustrated in FIG. 12.

Although the exemplary embodiment of the present disclosure has explained and illustrated the stopper (130) formed by cutting and bending a part of the floor plate (111) of the bottom case (110), the present disclosure is not limited thereto. For example, instead of cutting and bending a part of the floor plate (111) of the bottom case (110), an ‘L’-shaped stopper may be attached to the floor plate (111) of the bottom case (110) using welding or an adhesive.

Meanwhile, although the exemplary embodiment of the present disclosure has explained and illustrated the stopper (130) formed by cutting and bending a part of the floor plate (111) of the bottom case (110), the present disclosure is not limited thereto. For example, a part of the floor plate (121) of the upper case (120) of the case (100) may be cut out and bent to form a stopper (125) stopping the second driving unit (300) in a case the weight (310) of the second driving unit (300) enters into the NEVR.

The stopper (125) formed by cutting and bending a part of the floor plate (121) of the upper case (120) is formed on the floor plate (121) of the upper case (120) corresponding to an outside of the weight (310). The stopper (125) may be arranged in between the first and second elastic units (332, 334) of the elastic unit (330).

The stopper (125) formed on the floor plate (121) of the upper case (120) is inhibited from being in contact with the second driving unit (300) in a case the second driving unit (300) is vibrated within the EVR, and the stopper (125) is brought into contact with the second driving unit (300) in a case the second driving unit (300) is vibrated in the NEVR.

In a case a part of the floor plate (121) of the upper case (120) is cut out and bent to form the stopper (125), a foreign object may be introduced through the floor plate (121) of the upper case (120), such that a foreign object infuse inhibition membrane (127) covering the opening formed in the course of forming the stopper (125) may be formed at the floor plate (121) of the upper case (120) corresponding to the opening forming the stopper (125).

Meanwhile, the stopper (125), instead of cutting and bending a part of the floor plate (121) of the upper case (120), an ‘L’-shaped stopper (125) may be attached to an inner lateral surface of the floor plate (121) of the upper case (120) using welding or an adhesive.

Although the exemplary embodiment of the present disclosure has explained and illustrated the inhibition of destruction of the elastic unit caused by shock and/or vibration applied to VD of the second driving unit (300), the direction and position of the stopper and stopper unit may be changed to inhibit destruction and shape change of the elastic unit caused by shock and/or vibration applied vertical to the VE of the second driving unit (300).

As apparent from the foregoing, the linear vibrator based on the concept according to exemplary embodiments of the present disclosure has an industrial applicability in that, in a case a second driving unit deviates from an EVR to enter into an NEVR due to shock and/or vibration applied from outside, a stopper formed on a case and a stopper unit formed on the second driving unit are brought into contact to inhibit the second driving unit from entering into the NEVR, whereby the elastic unit reciprocating the second driving unit can be inhibited from being destroyed or damaged to reduce noise of the linear vibrator and inhibit the reduced life of the linear vibrator.

The above-mentioned linear vibrator according to exemplary embodiments of the present disclosure and attached drawings may, however, be embodied in many different forms and should not be construed as limited to the embodiment set forth herein. Thus, it is intended that embodiment of the present disclosure may cover the modifications and variations of this disclosure provided they come within the scope of the appended claims and their equivalents.

What is claimed is:

1. A linear vibrator, the linear vibrator comprising:
a case providing an inner space;
a first driving unit arranged inside the case;
a second driving unit arranged inside the case to be driven to a horizontal direction relative to the first driving unit; and
an elastic unit arranged on lateral surfaces opposite the second driving unit to elastically support the second driving unit to the case.

2. The linear vibrator of claim 1, wherein the case includes an upper case and a bottom case coupled to the upper case, and the case includes a magnetic substance.

3. The linear vibrator of claim 1, wherein the first driving unit includes a magnet secured inside the case, and the second driving unit includes a coil block wound by a coil, a weight fixing the coil block, a circuit substrate secured to the weight and electrically connected to the coil block, and a flexible circuit substrate, one side of which being secured to the case, and the other side of which being opposite to the one side and being electrically connected to the circuit substrate.

4. The linear vibrator of claim 2, wherein the circuit substrate is formed with a first terminal unit, and the other side of the flexible circuit substrate may be formed with a second terminal unit, where the first and second terminal units are electrically connected.

5. The linear vibrator of claim 2, wherein the flexible circuit substrate is bent at least once to a vibration direction of the second driving unit.

6. The linear vibrator of claim 2, wherein the elastic unit includes a back yoke unit secured to the weight, and springs formed at both sides of the back yoke unit and bent at least once.

7. The linear vibrator of claim 6, wherein the elastic unit includes a spring guide arranged at a connected area between the back yoke unit and each spring unit to inhibit the each spring unit from being short-circuited from the back yoke unit.

8. The linear vibrator of claim 1, wherein a pair of damping magnets is diagonally formed between the second driving unit and the case, and an area corresponding to each damping magnet in the second driving unit is formed with a lug.

9. The linear vibrator of claim 8, wherein each of the damping magnets is arranged with a magnetic substance.

10. The linear vibrator of claim 1, wherein the first driving unit includes a circuit substrate secured to the case and a coil block electrically connected to the circuit substrate, the second driving unit horizontally moving relative to the first driving unit includes a magnet opposite to the first driving unit and a weight securing the weight, and the case is formed with a stopper restricting movement of the second driving unit to inhibit the second driving unit from deviating from a normal moving range of the second driving unit.

11. The linear vibrator of claim 10, wherein the stopper does not contact the second driving unit at an EVR (Effective Vibration Range) of the second driving unit, and contacts the second driving unit, in a case the second driving unit moves to an NEVR (Non-Effective Vibration Range) other than the vibration range.

12. The linear vibrator of claim 11, wherein the weight is formed with stopper units hitching at the stopper at each NEVR.

13. The linear vibrator of claim 12, wherein the stoppers are protruded from both distal ends of a bottom surface of the weight opposite to the coil block.

14. The linear vibrator of claim 10, wherein a pair of stoppers is arranged at both sides of the stator.

15. The linear vibrator of claim 10, wherein the stopper is formed by cutting a part of the bottom case of the case and by bending the cut bottom case.

16. The linear vibrator of claim 15, further comprising a foreign object infuse inhibition membrane blocking an opening of the bottom case, so that a foreign object can be inhibited by the stopper from entering through the opening formed at the bottom case.

17. The linear vibrator of claim 15, wherein the stopper is attached to an inner lateral plate of a floor plate of the bottom case.

18. The linear vibrator of claim 10, wherein the stopper is formed by cutting a part of a floor plate of the upper case and by being bent from the floor plate of the upper case.

19. The linear vibrator of claim 18, further comprising a foreign object infuse inhibition membrane blocking an opening of the upper case, so that a foreign object can be inhibited by the stopper from entering through the opening formed at the upper case.

20. The linear vibrator of claim 19, wherein the stopper is attached to an inner lateral plate of the floor plate of the upper case.
